(19) United States
(12) Patent Application Publication
(10) Pub. No.: US 2009/0002277 A1
(43) Pub. Date: Jan. 1, 2009

(54) PLASMA DISPLAY PANEL DEVICE

(76) Inventors: Ki Rack Park, Gumi-si (KR); Jong Woon Bae, Gumi-si (KR); Seong Hwan Ryu, Gumi-si (KR)

Correspondence Address: KED & ASSOCIATES, LLP, P.O. Box 221200, Chantilly, VA, 20153-1200, US

(21) Appl. No.: 12/146,632

(22) Filed: Jun. 26, 2008

(30) Foreign Application Priority Data
Jun. 26, 2007 (KR) 10-2007-0063144

(51) Int. Cl. G09G 3/28; G09G 3/10

(52) U.S. Cl. 345/60; 315/169.4

(57) ABSTRACT

The present invention relates to a plasma display panel device. The plasma display panel device includes a set-up period, a first set-down period, and a second set-down period in this order. During the set-up period, a voltage of a reset signal gradually rises. During the first set-down period, the voltage gradually falls down from a positive voltage. During the second set-down period, the voltage falls down to a negative voltage.

The plasma display panel device may reduce the incidence of bright spots because there is no abrupt variation in voltage during a reset period for a reset signal, and this may improve image quality of the plasma display panel device.

### CROSS-REFERENCE TO RELATED APPLICATION

This application claims priority to Korean patent application 10-2007-0063144 filed on Jun. 26, 2007, the disclosure of which is incorporated by reference herein.

### BACKGROUND OF THE INVENTION

1. Technical Field

The present invention is directed to a plasma display panel device, and more specifically to a driving signal for driving a plasma display panel included in the plasma display panel device.

2. Discussion of Related Art

In general, a plasma display panel includes an upper substrate and a lower substrate. Barrier ribs are positioned between the upper substrate and the lower substrate, and each of the barrier ribs defines a unit cell. An inert gas is injected in each unit cell, which consists of a primary discharge gas and a small amount of Xe, wherein the primary discharge gas includes any one of Ne, He, and a mixture of Ne and He. The inert gas emits vacuum ultraviolet rays when being discharged by a high frequency voltage, and the emitted vacuum ultraviolet rays excite phosphors formed in the barrier ribs to display an image. This plasma display panel may be made thinner and lighter, and therefore, it gains popularity as a next generation display.

A plasma display panel (PDP) device may be driven in a time-division manner, with one frame divided into plural subfields, wherein each subfield may include a reset period for initializing the whole discharge cells, an address period for selecting a cell to initiate a discharge, and a sustain period for creating a sustain discharge in the selected cell.

There is a need for a plasma display panel (PDP) device capable of generating a stable reset discharge during a reset period.

### SUMMARY OF THE INVENTION

An exemplary embodiment of the present invention provides a plasma display panel device including a plasma display panel having an upper substrate on which a scan electrode and a sustain electrode are formed; and a driver supplying the scan electrode with a reset signal for initializing a discharge cell, wherein first and second reset signals are sequentially supplied to the scan electrode, the first and second signals including a set-up period during which voltages of the first and second signals gradually increase and a set-down period during which voltages of the first and second signals gradually decrease, the set-up period and the set-down period included in at least one of plural subfields constituting one frame, wherein the set-down period of the first and second reset periods includes a first set-down period during which the voltages of the first and second signals gradually decrease from a positive voltage and a second set-down period during which the voltages of the first and second signals gradually decrease to a negative voltage.

### BRIEF DESCRIPTION OF THE DRAWING

The present invention will become more apparent by describing in detail exemplary embodiments thereof with references to the attached drawings, in which:

FIG. 1 is a perspective view illustrating a construction of a plasma display panel according to an exemplary embodiment of the present invention;

FIG. 2 is a view illustrating an array of electrodes included in a plasma display panel according to an exemplary embodiment of the present invention;

FIG. 3 is a timing diagram illustrating a time-division driving method of a plasma display panel according to an exemplary embodiment of the present invention, wherein one frame is divided into plural subfields;

FIGS. 4 to 10 are timing diagrams illustrating a waveform of a driving signal of driving a plasma display panel according to an exemplary embodiment of the present invention;

FIG. 11 is a timing diagram illustrating the number of reset signals according to an exemplary embodiment of the present invention;

FIG. 12 is a timing diagram illustrating another type of reset signal according to an exemplary embodiment of the present invention;

FIG. 13 is a circuit diagram illustrating an exemplary driver according to an exemplary embodiment of the present invention;

FIGS. 14a to 14l are circuit diagrams illustrating an exemplary operation of the driver shown in FIG. 13 according to an exemplary embodiment of the present invention;

FIGS. 15, 16 are timing diagrams illustrating a waveform of a driving signal of driving a plasma display panel according to an exemplary embodiment of the present invention;

FIGS. 17, 18 are timing diagrams illustrating a waveform of a driving signal of driving a plasma display panel according to an exemplary embodiment of the present invention; and

FIG. 19 is a timing diagrams illustrating a waveform of a driving signal of driving a plasma display panel according to an exemplary embodiment of the present invention.

### DETAILED DESCRIPTION OF EXEMPLARY EMBODIMENTS

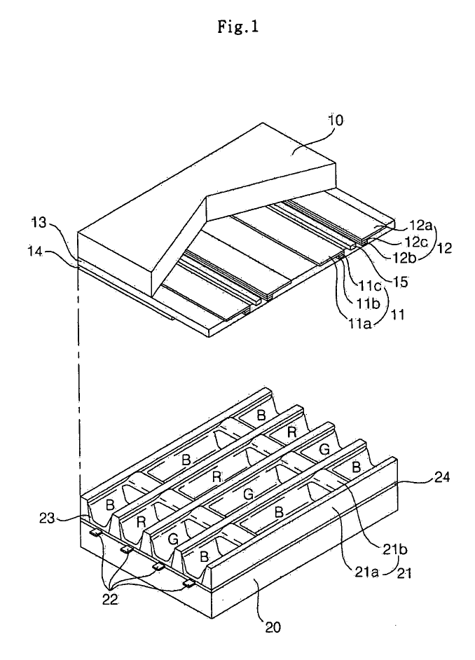

Hereinafter, exemplary embodiments of the present invention will be described in more detail with reference to accompanying drawings. The present invention is directed to a plasma display panel device, and more specifically to a driving signal for driving a plasma display panel included in the plasma display panel device. FIG. 1 is a perspective view illustrating a construction of a plasma display panel according to an exemplary embodiment of the present invention.

Referring to FIG. 1, a plasma display panel includes an upper substrate 10 and a lower substrate 20. A maintaining electrode pair, which includes a scan electrode 11 and a sustain electrode 12, is arranged on the upper substrate 10, and an address electrode 22 is arranged on the lower substrate 20.

The scan electrode 11 includes a transparent electrode 11a that typically formed of ITO (Indium Tin Oxide) and a bus electrode 11b typically formed in a single layer of Ag or Cr, or in a multiple layer of Cr/Cu/Cr or Cr/Al/Cr. The sustain electrode 12 also includes a transparent electrode 12a that typically formed of ITO (Indium Tin Oxide) and a bus electrode 12b typically formed in a single layer of Ag or Cr, or in a multiple layer of Cr/Cu/Cr or Cr/Al/Cr. The bus electrodes 11b and 12b are arranged on the transparent electrodes 11a and 12a, respectively, and serves to reduce voltage drop due to the transparent electrodes 11a and 12a, respectively. Although a case has been described in the exemplary embodiment of the present invention, where the bus electrodes 11b and 12b are stacked on the transparent electrodes 11a and 12a, respectively, the present invention is not limited thereto. For example, the maintaining electrode pair 11 and 12 may include only the bus electrodes 11b and 12b without the transparent electrodes 11a and 12a. Such electrode structure may save costs necessary to manufacture the panels thanks to no necessity of the transparent electrodes 11a and 12a. In such electrode structure, various photosensitive materials may be used for the bus electrodes 11b and 12b except for the aforementioned materials.

A first black matrix (BM) 15 may be positioned between the scan electrode 11 and the sustain electrode 12. The first black matrix 15 absorbs external light to reduce reflection of the external light, and improves purity and contrast ratio of the upper substrate 10.

The first black matrix 15 is arranged on the upper substrate 10 to overlap the barrier rib 21. And, second black matrixes 11c and 12c are further arranged between the transparent electrode 11a and the bus electrode 11b and between the transparent electrode 12a and the bus electrode 12b, respectively. The second black matrixes 11c and 12c are called “black layer” or “black electrode layer”. The first black matrix 15 may be formed along with or separately from the second black matrixes 11c and 12c. In the former case, the first black matrix 15 may be physically connected to the second black matrixesllc and 12c, but in the latter case, the first black matrix 15 may be physically disconnected from the second black matrixes 11c and 12c.

Also, in the former case, the first black matrix 15 and the second black matrixes 11c and 12c may be formed of a same material, but in the latter case, of a different material.

An upper dielectric layer 13 and a protection layer 14 are sequentially stacked on the upper substrate 10 to cover the scan electrode 11 and the sustain electrode 12. The upper dielectric layer 13, on which charged particles generated during discharge are accumulated, may protect the maintaining electrode pair 11 and 12. The protection layer 14 protects the upper dielectric layer 13 from sputtering of the charged particles generated upon gas discharge, and raises emission efficiency of secondary electrons. The protection layer 14 may be made of a material which has a high secondary electron emission coefficient, for example, such as MgO.

The address electrode 22 is formed to cross the scan electrode 11 and the sustain electrode 12. A lower dielectric layer 23 and a barrier rib 21 are formed on the lower substrate 20 on which the address electrode 22 has been arranged. A phosphor layer is formed on the surface of the lower dielectric layer 23 and the barrier rib 21.

The phosphor layer is excited by ultraviolet rays generated upon gas discharge to emit any one of red (R), green (G), and blue (B) visible rays. The upper substrate 10, the lower substrate 20, and the barrier rib 21 constitute a discharge space in which an inert mixture gas is injected that includes He+Xe, Ne+Xe, or He+Ne+Xe.

Although a case has been described in this exemplary embodiment of the present invention, where each of red discharge cells, green discharge cells, and blue discharge cells is arranged along a same line, the present invention is not limited thereto. For example, a red discharge cell, a green discharge cell, and a blue discharge cell may be arranged in the shape of a Greek letter “Δ”. The discharge cell may be formed in various shapes, such as a pentagon, a hexagon, as well as a tetragon.

The discharge cells may be equal in width to each other and any one of the red discharge cell, green discharge cell, and blue discharge cell may be different in width from the others.

The barrier rib 21 physically separates one discharge cell from the others, and prevents ultraviolet rays and visible rays generated upon discharge from leaking to neighboring discharge cells. The barrier ribs may be arranged in a stripe type, a well type, a delta type, and a honeycomb type. The barrier rib 21 includes a vertical barrier rib 21a and a horizontal barrier rib 21b that crosses the vertical barrier rib 21a . The vertical barrier rib 21a and the horizontal barrier rib 21b define a discharge cell.

The barrier rib 21 may have various structures other than the structure illustrated in FIG. 1. For example, the barrier rib 21 may be configured so that the vertical barrier rib 21a is different in height from the horizontal barrier rib 21b—this is called “height-different type barrier rib”. The barrier rib 21 may be also configured so that at least one of the vertical barrier rib 21a and the horizontal barrier rib 21b has a channel that can be used as an exhaust gas pathway—this is called “channel type barrier rib”. The barrier rib 21 may be configured so that at least one of the vertical barrier rib 21a and the horizontal barrier rib 21b has a hollow—this is called “hollow type barrier rib”.

In the height-different type barrier rib, the horizontal barrier rib 21b may be higher in height than the vertical barrier rib 21a. In the channel type barrier rib or hollow type barrier rib, a channel or hollow may be formed in the horizontal barrier rib 21b.

Although a case has been described where the barrier rib 21 is formed on the lower substrate 20, the present invention is not limited thereto. The barrier rib 21 may be formed on the upper substrate 10.

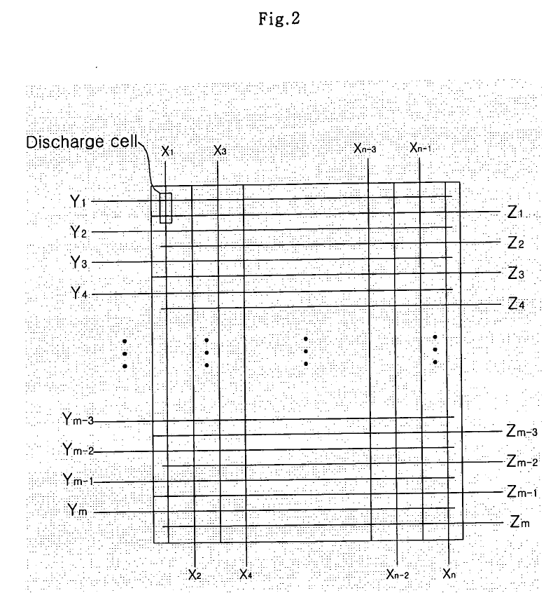

FIG. 2 is a view illustrating an array of electrodes included in a plasma display panel according to an exemplary embodiment of the present invention, wherein plural discharge cells included in the plasma display panel may be arranged in a matrix pattern. Plural discharge cells are arranged near the intersections of scan electrode lines Y1 to Ym and sustain electrode lines Z1 to Zm, and address electrode lines X1 to Xn. The scan electrode lines Y1 to Ym may be driven sequentially or simultaneously, and the sustain electrode lines Z1 to Zm may be driven simultaneously. The address electrode lines X1 to Xn may be driven sequentially. The address electrode lines X1 to Xn may be divided into odd-numbered address electrode lines and even-numbered address electrode lines for driving.

The array of electrodes shown in FIG. 2 is only an example of array of electrodes in the PDP according to an exemplary embodiment of the present invention. Therefore, the present invention is not limited to the array of electrodes and driving method shown in FIG. 2. For example, the present invention may employ a dual scan method, where two of the scan electrode lines Y1 to Ym are simultaneously scanned. Also, the address electrode lines X1 to Xn may be divided in upper and lower parts with respect to a central axis of the panel for driving.

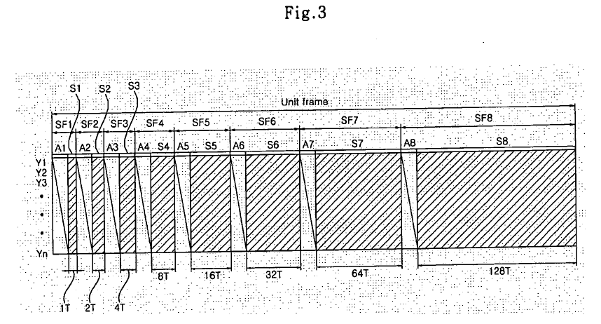

FIG. 3 is a timing diagram illustrating a time-division driving method of a plasma display panel according to an exemplary embodiment of the present invention, wherein one frame is divided into plural subfields. A unit frame may be separated into, e.g. eight subfields SF1 to SF8 for time-division gray scale display. Each of the subfields SF1 to SF8 includes a reset period (not shown), an address period A1 to A8, and a sustain period S1 to S8.

In accordance with an exemplary embodiment of the present invention, a reset period may be omitted from at least one of the plural subfields. For example, the reset period may exist only within the first subfield, or only within the first subfield and a subfield positioned between the first subfield and the last subfield.

During each address period A1 to A8, a display data signal is applied to the address electrode X and its corresponding scan pulse is sequentially applied to each scan electrode Y.

During each sustain period S1 to S8, a sustain pulse is alternately applied to the scan electrode Y and the sustain electrode Z, so that sustain discharge occurs in the discharge cells in which wall charges are generated during the address period A1 to A8.

The brightness of the PDP is in proportion to the number of sustain discharge pulses generated during the sustain periods S1 to S8 occupying a unit frame.

In a case where one frame embodying one image is represented as eight subfields and 256 gray scales, the number of sustain pulses may be differently assigned to each subfield in the ratio of 1, 2, 4, 8, 16, 32, 64, and 128.

The brightness of 133 grays scales may be achieved by causing a sustain discharge while addressing cells during subfields SF1, SF3, and SF8.

The number of sustain discharges assigned to each subfield may be determined according to weight value of subfields in an automatic power control (APC) stage.

Although a case has been described in FIG. 3 where one frame is divided into eight subfields, the present invention is not limited thereto, and the number of subfields constituting one frame may be varied depending on design and specifications.

For example, one frame may be separated into more than eight subfields, such as 12 subfields and 16 subfields in order to drive the PDP.

Also, the number of sustain discharges assigned to each subfield may change variously considering gamma properties or panel characteristics. For example, the degree of gray scale assigned to subfield SF4 may be lowered from 8 to 6, and the degree of gray scale assigned to subfield 6 may be raised from 32 to 34.

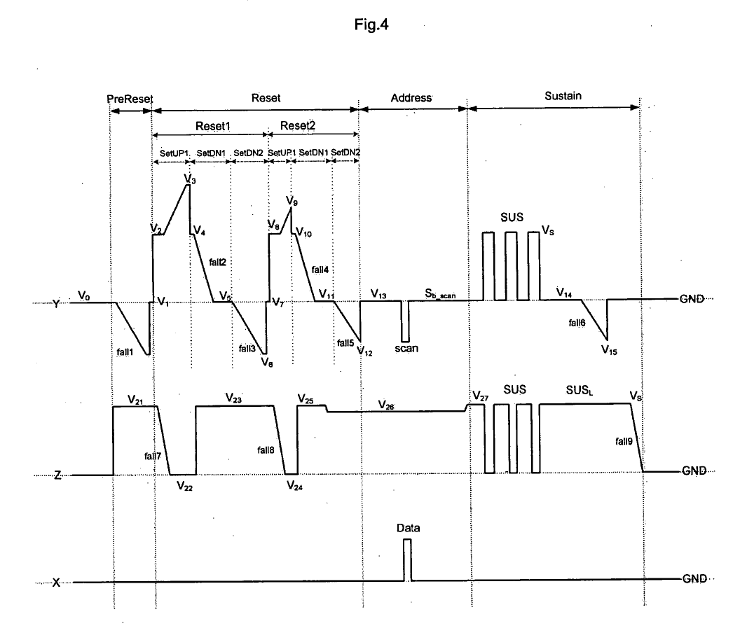

FIGS. 4 to 10 are timing diagrams illustrating a waveform of a driving signal of driving a plasma display panel according to an exemplary embodiment of the present invention. Hereinafter, exemplary embodiments of the present invention will be described primarily with reference to FIG. 4, and the repetitive descriptions will be briefly made or omitted.

Referring to FIG. 4, each subfield may include a pre-reset period, a reset-period, an address period, and a sustain period. The pre-reset period generates positive wall charges on the scan electrodes Y and negative wall charges on the sustain electrodes Z. The reset period initializes the overall discharge cells through the distribution of the wall charges formed during the pre-reset period. The address period selects discharge cells. The sustain period sustains discharge occurring in the selected discharge cells. The pre-reset period may be omitted.

A reset period includes a set-up period and a set-down period. During the set-up period, a ramp-up signal, whose voltage gradually rises up, is simultaneously applied to the overall scan electrodes to cause a tiny discharge in the whole discharge cells, and as a consequence, wall charges are generated. During the set-down period, a ramp-down signal, whose voltage gradually falls from a positive voltage whose peak is lower than that of the ramp-up signal, is simultaneously applied to the whole scan electrodes Y to cause an erase discharge in the overall discharge cells, and accordingly, unnecessary charges are erased from space charges and wall charges generated by set-up discharge. During a reset period, a reset signal including the ramp-up signal and the ramp-down signal is applied to the scan electrode Y. During a reset period, two or more reset signals may be applied to the scan electrode Y. In a case where a reset signal is only applied to the scan electrode Y once, the wall charges in the whole discharge cells may fail to remain suitable for an address discharge due to instability of the PDP. Accordingly, it can be possible for all the wall charges in the whole discharge cells to remain suitable for an address discharge by applying a reset signal to the scan electrode Y twice. The wall charges which are properly generated and remaining in the discharge cells, may reduce the occurrence of unwanted discharge during an address period.

In this exemplary embodiment, a first ramp-up signal is applied to the scan electrode Y, which rapidly rises from a first voltage V1 to a second voltage V2 and then gradually rises from the second voltage V2 to a third voltage V3 during a first set-up period SetUP1. The first voltage V1 may be a ground voltage GND and the second voltage V2 may be a sustain voltage Vs.

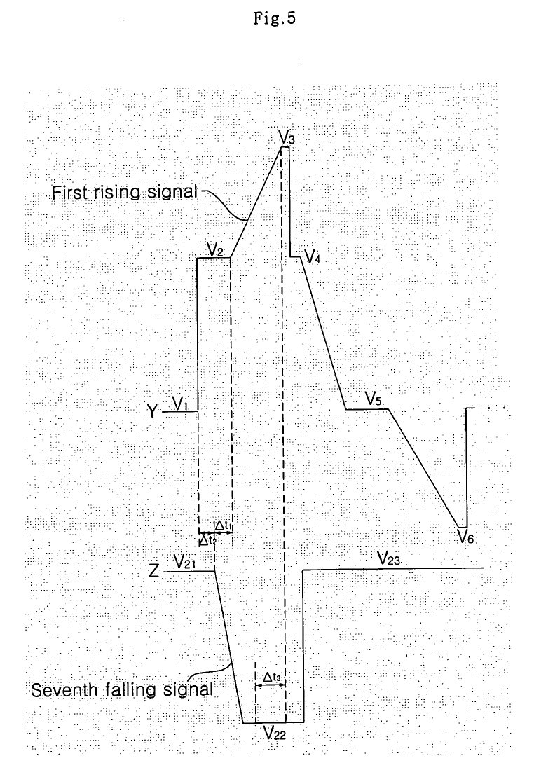

The first set-up period SetUP1 may be described in more detail with reference to FIG. 5.

Referring to FIG. 5, while the first ramp-up signal is supplied to the scan electrode Y, a seventh ramp-signal is supplied to the sustain electrode Z, whose voltage gradually falls down. The voltage of the seventh ramp-down signal gradually decreases from a twenty-first voltage V21 to a twenty-second voltage V22.

As such, if the seventh ramp-down signal is supplied to the sustain electrode Z while the first ramp-up signal is supplied to the scan electrode Y during a set-up period, a stable reset discharge may occur between the scan electrode Y and the sustain electrode Z even though the voltage of the first ramp-up signal is reduced, and this may induce efficient initialization.

In the above case, the reset discharge may be further uniformly generated by gradually decreasing the voltage applied to the sustain electrode Z while gradually increasing the voltage applied to the scan electrode Y.

In a case where a ramp-down signal, for example, the seventh ramp-down signal is excessively rapidly applied to the sustain electrode Z, the reset discharge is biased toward the sustain electrode Z in the discharge cell, so that the reset discharge may unstably take place. Accordingly, the ramp-down signal may be supplied after the voltage applied to the scan electrode Y has risen from the first voltage V1 to the second voltage V2. For example, as shown in FIG. 5, the seventh ramp-down signal is supplied to the sustain electrode Z a predetermined time interval (Δt2) after the voltage applied to the scan electrode Y has risen from the first voltage V1 to the second voltage V2.

The ramp-down signal may be supplied to the sustain electrode Z before the ramp-up signal is supplied to the scan electrode Y so that the reset discharge may be generated more stably. For example, as shown in FIG. 5, the ramp-down signal may be supplied to the scan electrode Y a predetermined time interval (Δt1) before the first ramp-up signal is supplied to the sustain electrode Z.

If an ending time point of the ramp-down signal is excessively delayed, in a case where the reset signal is applied to two or more scan electrodes Y, the discharge may become unstable during the second set-up period in the second reset period after the first reset period, or the address discharge may become unstable during the address period after the reset period. Accordingly, the ending time point of the ramp-down signal may antecede the ending time point of the ramp-up signal. For example, as shown in FIG. 5, the ending time point of the seventh ramp-down signal may antecede the ending time point of the first ramp-up signal by a time interval (Δt3).

The twenty-first voltage V21, which is a positive voltage, needs to be maintained to apply the seventh ramp-down signal to the sustain electrode Z. That is, the first sustain bias signal is maintained as the twenty-first voltage and then includes the seventh ramp-down signal whose voltage gradually decreases. The slope of the rising twenty-first voltage is larger in absolute value than that of the falling seventh ramp-down signal. Commonly, a period during which the voltage maintains constant in the first bias signal overlaps the pre-reset period during which a gradually falling voltage is applied to the scan electrode Y. The rising slope of the first sustain bias signal may become steep so that the pre-reset period does not last long.

The rising slope of the voltage applied to the scan electrode Y, which rises from the first voltage V1 to the second voltage V2, may be substantially equal to the rising slope of the sustain signal supplied to at least one of the scan electrode Y and the sustain electrode Z during the sustain period after the reset period in order to reduce incidence of noises and raise driving efficiency during the set-up period in the reset period.

The set-up period shown in FIG. 4 is followed by first and second set-down periods during which the voltage gradually decreases. In this exemplary embodiment, a second ramp-down signal is supplied to the scan electrode Y during the first set-down period, whose voltage rapidly falls from a third voltage V3, which is a peak voltage in the set-up period, to a fourth voltage V4, which is a positive voltage, and then gradually falls from the fourth voltage V4 to a fifth voltage V5. Then, a third ramp-down signal is supplied to the scan electrode Y during the second set-down period, whose voltage gradually falls from the fifth voltage V5 to a sixth voltage V6 which is a negative voltage.

As the third ramp-down signal is supplied to the scan electrode Y, a weak erase discharge, i.e. set-down discharge, takes place in the discharge cell. This set-down discharge allows as many wall charges as an address discharge may occur stably to remain in the discharge cell.

The third ramp-down signal may be supplied to the scan electrode Y after the voltage has rapidly fallen from the fourth voltage V4 to the fifth voltage V5. However, this abrupt variation in voltage may cause a discharge, which in turn gives rise to bright spots on the panel. Accordingly, the incidence of bright spots may be suppressed using the second ramp-down signal whose voltage gradually falls down.

The second ramp-down signal creates a dark discharge, i.e. erase discharge. In a case where a reset signal is only applied to the scan electrode Y once, wall charges in the whole discharge cells may fail to remain suitable for an address discharge due to instability of the PDP. Accordingly, it can be possible for all the wall charges in the whole discharge cells to remain necessary for an address discharge by applying the first and second reset signals to the scan electrode Y during a reset period of at least one subfield in a frame.

The exemplary embodiment of the present invention is characterized by a plasma display panel device comprising a plasma display panel having an upper substrate on which a scan electrode and a sustain electrode are formed; and a driver supplying the scan electrode with a reset signal for initializing a discharge cell, wherein

first and second reset signals are sequentially supplied to the scan electrode, the first and second signals including a set-up period during which voltages of the first and second signals gradually increase and a set-down period during which voltages of the first and second signals gradually decrease, the set-up period and the set-down period included in at least one of plural subfields constituting one frame, wherein the set-down period includes a first set-down period during which the voltages of the first and second signals gradually decrease from a positive voltage and a second set-down period during which the voltages of the first and second signals gradually decrease to a negative voltage.

A second reset period (Reset2) subsequent to the first reset period (Reset1) is similar to the first reset period (Reset1), and therefore, its repetitive description will be omitted.

During the second reset period, a second reset signal is applied to the scan electrode Y, which includes a second ramp-up signal, a fourth ramp-down signal, and a fifth ramp-down signal.

The voltage of the second ramp-up signal, applied to the scan electrode Y, rises from a seventh voltage V7 to an eighth voltage V8, and then gradually rises from the eighth voltage V8 to a ninth voltage V9. The eighth voltage V8 may be substantially equal to the second voltage V2 of the first reset signal, and the ninth voltage V9 substantially equal to the third voltage V3 of the first reset signal.

The fourth ramp-down signal gradually falls from a tenth voltage V10, which is a negative voltage, to an eleventh voltage V11, and the fifth ramp-down signal gradually falls from the eleventh voltage V11 to a twelfth voltage V12, which is a negative voltage.

The slope of the second, third, fourth, and fifth ramp-down signals may range from about −1.4V/μs to about −2.5V/μs. If the slope of the above ramp-down signals is gentler than −1.4V/μs, the reset period may last too long, and if the slope of the above ramp-down signals is steeper than −2.5V/μs, the voltage of the above ramp-down signals may abruptly fall down, which may cause a discharge.

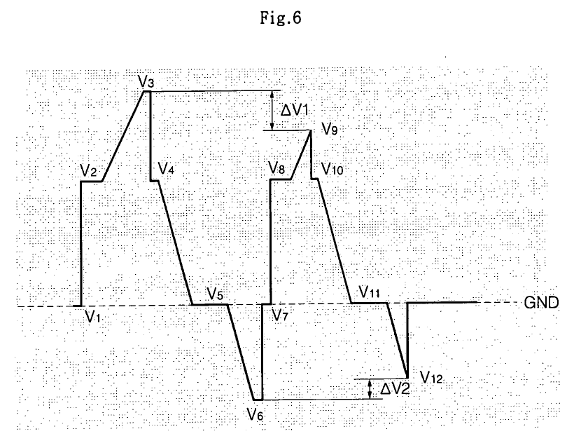

The falling slope of the second ramp-down signal may be equal to that of the fifth ramp-down signal as shown in FIG. 6 for the simplicity of configuration and operation of the circuit.

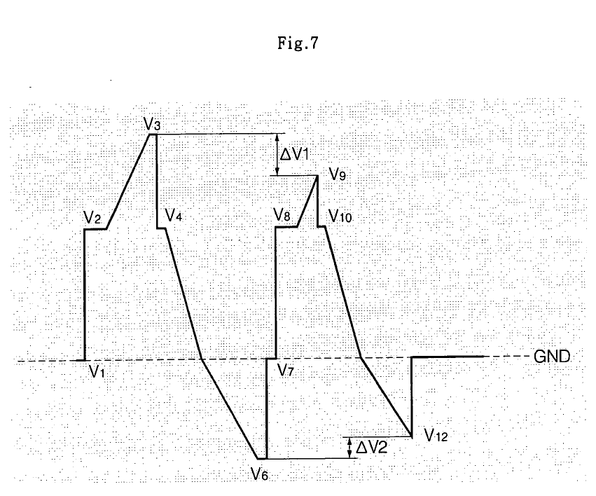

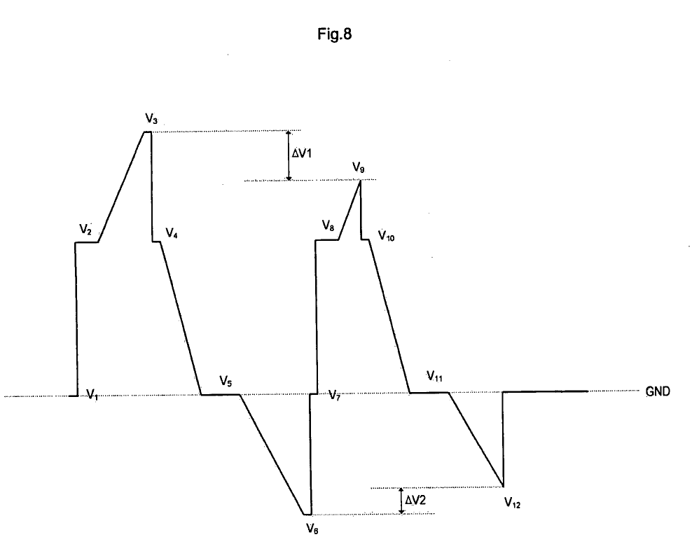

FIGS. 7 and 8 depict a difference between the first reset signal and the second reset signal.

Referring to FIG. 7, the ninth voltage V9, which is a peak voltage of the second reset signal, is smaller than the third voltage V3, which is a peak voltage of the first reset signal. The second reset signal permits the wall charges to be accumulated in the discharge cell again. Even though the second reset signal does not reach the peak voltage of the first reset signal, the wall charges may uniformly remain in the discharge cell. This enables reduce power consumption because the voltage depletes less.

The voltage differential (ΔV1) between the third voltage V3 and the ninth voltage V9 may range from about 40V to about 60V. The voltage differential (ΔV1) needs to be more than 40V so that the plasma display panel device which is driven with a high voltage may reduce power consumption. Since the second reset signal is supplied to the scan electrode Y after the first reset signal has been supplied to the scan electrode Y, it is advantageous to use the wall charges caused due to the first reset discharge. In this case, however, if negative wall charges and positive wall charges are created at the scan electrode Y and at the sustain electrode Z, respectively, more than necessary, a strong discharge may take place, and this may give rise to image-sticking bright spots on the panel. Accordingly, the maximum voltage of the first reset signal may be about 40V above the maximum voltage of the second reset signal.

If the voltage differential (ΔV1) is more than 60V, the period during which the voltage gradually increases becomes too short, and this makes the set-up period of the second reset period meaningless. Accordingly, the negative wall charges created in the whole discharge cells by the second reset signal may be difficult to uniformly distribute near the scan electrode Y.

The twelfth voltage V12, which is the minimum voltage of the fifth ramp-down signal, is adapted to be higher than the sixth voltage V6, which is the minimum voltage of the third ramp-down signal. This allows for the optimization of the amount of wall charges to be erased during the second set-down period of the second reset period, and therefore, it might be advantageous because sufficient amounts of wall charges may be utilized during an address period after the second reset period. In addition, the maximum voltage of the second reset signal during the set-up period is not large, and this makes it unnecessary to erase large amounts of wall charges. Similarly to the advantage coming from the voltage differential between the maximum voltages, power consumption might be saved.

The voltage differential (ΔV2) between the twelfth voltage V12, which is the minimum voltage of the second reset signal, and the sixth voltage V6, which is the minimum voltage of the first reset signal, may range from about 5V to about 20V. If the voltage differential (ΔV2) is less than 5V, this voltage differential becomes meaningless in terms of losses in circuit, influence from noises, voltage peaking, etc. If the voltage differential (ΔV2) is more than 20V, it could be difficult to ensure sufficient set-down period of the second reset signal, and this may lead to a failure of erase of wall charges. A consequence may be the incidence of unwanted discharges.

The first set-down period of the first reset period may further include a time period (hereinafter, referred to as “floating period”) during which the fifth voltage V5 floats at a constant level for a constant time. The floating period is longer than a time period included in the set-up period of the second reset period, except for the period during which the voltage gradually increases, i.e. the period during which the seventh voltage V7 and the eighth voltage V8 are maintained. The set-down period may also include a time period during which the voltage gradually decreases and then maintains constant so that strong discharges do not occur during the set-down period. The floating period may be adjusted in length according to the voltage difference between the first reset signal and the second reset signal and the length in period so as to erase unnecessary wall charges.

An eighth ramp-down signal is applied to the sustain electrode Z as in the first reset period. The relationship between the second ramp-up signal and the eighth ramp-down signal is substantially identical to that between the first ramp-up signal and the seventh ramp-down signal in the first reset period.

The eighth ramp-down signal, whose voltage gradually falls down, is applied to the sustain electrode Z during the set-up period of the second reset period, as in the first reset period.

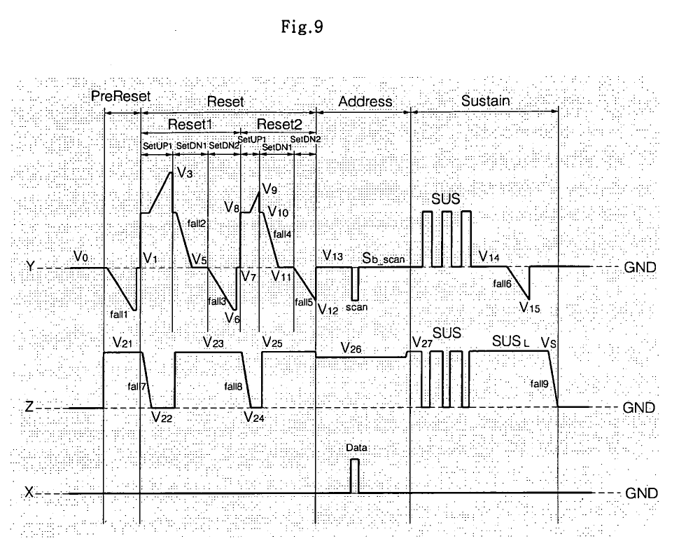

As shown in FIG. 9, a third sustain bias signal, which substantially maintains a twenty-fifth voltage V25, may be supplied to the sustain electrode Z during the second set-down period of the second reset period, and another sustain bias signal, i.e. the third sustain bias signal, which is supplied to the sustain electrode Z during the second set-down period and the address period, may be changed without maintaining at the same level.

In accordance with the above exemplary embodiment described with reference to FIG. 4, the voltage applied to the sustain electrode rises up to the twenty-fifth voltage V25 during the first set-down period of the second reset period and then maintains a twenty-sixth voltage V26 less than the twenty-fifth voltage V25 during the set-down period.

The exemplary embodiment of the present invention may prevent unwanted discharges by making the bias voltage become lowered only during the second set-down period of the second reset signal followed by the address period.

Since the sustain voltage becomes lowered corresponding to the minimum voltage in the second set-down period of the second reset period, there could occur a proper erase discharge.

In addition, the third sustain bias signal may last until the address period.

Moreover, the third sustain bias signal maintains the twenty-sixth voltage V26 for a constant time, and then rises up to a twenty-seventh voltage V27 before the sustain period. The twenty-seventh voltage V27 may be the sustain voltage Vs for the simplicity of configuration of the circuit. The twenty-fifth voltage V25 is substantially equal to the twenty-seventh voltage V27.

A pre-reset period may be added before the reset period. During the pre-reset period, another ramp-down signal, for example the first ramp-down signal, is supplied to the scan electrode Y, and still another ramp-down signal, for example the first sustain bias signal having the opposite polarity of the first ramp-down signal, is supplied to the sustain electrode Z.

Addition of the pre-reset period may enable sufficient wall charges to be accumulated in the discharge cells before the reset period, and this helps reset discharge to be advantageous.

The pre-reset period may be added not only before every reset period of the overall subfields in a frame but also before only the reset period of at least one subfield in a frame.

During the address period after the reset period, a scan bias signal is supplied to the scan electrode Y, which substantially maintains a voltage, for example thirteenth voltage V13, higher than the minimum voltage of the fifth ramp-down signal, i.e. twelfth voltage V12. In addition, a scan signal falling from the scan bias signal is supplied to the scan electrode Y.

The voltage of the scan bias signal may be substantially equal to a ground level voltage.

If the voltage of the scan bias signal is the ground level voltage, it is not necessary to add a driving circuit for supplying the scan bias signal to the scan electrode Y, and this may reduce the size of the driver as well as lower manufacturing costs.

In addition, the magnitude of the voltage of the scan signal (Scan) may be substantially equal to the magnitude (V3-V2) of the voltage of the ramp-up signal, for example the first ramp-up signal, supplied to the scan electrode Y during the reset period. If the magnitude of the voltage of the scan signal is substantially equal to the magnitude of the voltage of the ramp-up signal, the driving circuit for supplying the scan signal to the scan electrode Y is unnecessary, and the scan signal may be generated using the driving circuit creating the voltage of the ramp-up signal. As a consequence, manufacturing costs may be further reduced.

The pulse width of the scan signal (Scan) supplied to the scan electrode Y during the address period of at least one subfield may be different from the pulse width of the scan signal supplied to the scan electrode Y during the address period of the other subfields. For example, the pulse width of the scan signal supplied in a subfield may be smaller than that of the scan signal supplied in the previous subfield. The pulse width of the scan signal may gradually decrease in the order of 2.6 μs, 2.3 μs, 2.1 μs, and 1.9 μs, or 2.6 μs, 2.3 μs, 2.3 μs, 2.1 μs . . . 1.9 μs, and 1.9 μs.

As the scan signal is supplied to the scan electrode Y, data signal is supplied to the address electrode X correspondingly.

The voltage differential between the scan signal and data signal thusly supplied is added to the wall voltage caused by wall charges generated during the reset period, and therefore, an address discharge takes place in a discharge cell to which the data signal is supplied.

Afterwards, a sustain signal may be supplied to at least one of the scan electrode Y and the sustain electrode Z during the sustain period for displaying an image. For example, the sustain signal is alternately supplied to the scan electrode Y and the sustain electrode Z.

If the sustain signal is supplied to the scan electrode Y and the sustain electrode Z, the wall voltage in the discharge cell selected by address discharge is added to the sustain voltage Vs of the sustain signal, and therefore, a sustain discharge, i.e. display discharge occurs between the scan electrode Y and the sustain electrode Z.

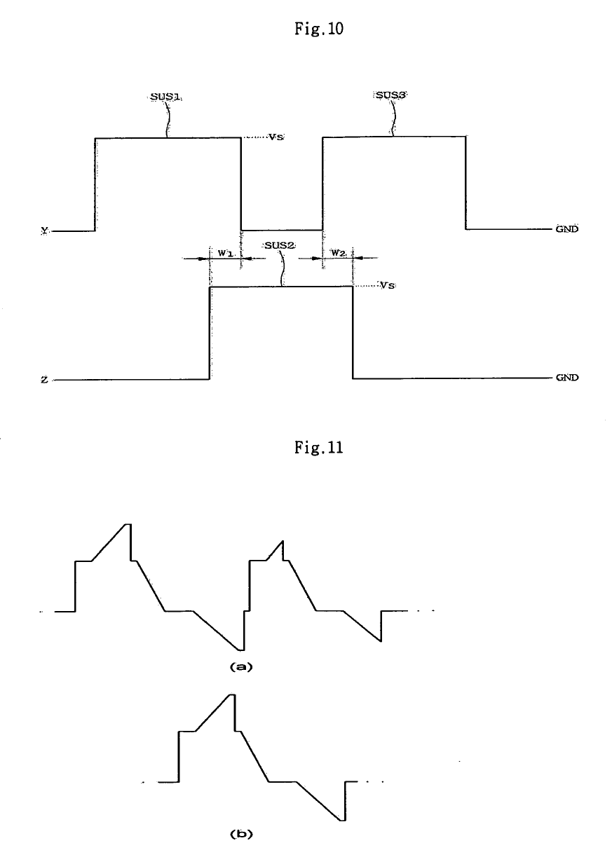

In addition, the sustain signal may be supplied to each of the scan electrode Y and the sustain electrode Z, and the sustain signal supplied to the scan electrode Y may overlap the sustain signal supplied to the sustain electrode Z. For instance, in a case where a first sustain signal SUS1 and a third sustain signal SUS3 are supplied to the scan electrode Y, and a second sustain signal SUS2 is supplied to the sustain electrode Z as shown in FIG. 10, the first sustain signal SUS1 and the second sustain signal SUS2 overlaps each other at an area W1, and the third sustain signal SUS3 and the second sustain signal SUS2 overlaps each other at an area W2.

Such overlapping of two sustain signals may raise discharge efficiency.

Meanwhile, plural sustain signals are supplied to the scan electrode Y or sustain electrode Z during a sustain period in at least one subfield, and the pulse width of at least one of the plural sustain signals may be different from that of the other sustain signals. For instance, the pulse width of the sustain signal first supplied to the scan electrode X or sustain electrode Z may be larger than that of the other sustain signals. This permits more stabilized sustain discharge.

Or, the sustain signal SUSL, which is last supplied to the sustain electrode Z, may be broader in pulse width than the other sustain signals.

The sustain signal SUSL may be followed by a ninth ramp-down signal to create a stable discharge during the next reset period or pre-reset period.

A sixth ramp-down signal, whose voltage gradually falls down, may be supplied to the scan electrode Y after the supplying of the whole sustain signals has been complete in order to create a stable discharge during the reset period or pre-reset period of the subsequent subfield.

The sixth ramp-down signal may overlap the sustain signal SUSL that is last supplied to the sustain electrode Z.

Although a case is depicted in FIG. 4, where the sustain signal SUSL and the sixth ramp-down signal are supplied to the sustain electrode Z and the scan electrode Y, respectively, during the sustain period of a subfield, the present invention is not limited thereto. For example, the sustain signal SUSL and the sixth ramp-down signal may be supplied to the sustain electrode Z and the scan electrode Y, respectively, during the pre-reset period of the next subfield. In other words, a period during which the sustain signal SUSL and the sixth ramp-down signal are supplied to the sustain electrode Z and the scan electrode Y, respectively, may be defined as the pre-reset period of the next subfield.

FIG. 11 is a timing diagram illustrating the number of reset signals according to an exemplary embodiment of the present invention.

Referring to FIG. 11, at least two reset signals may be supplied to the scan electrode during a reset period included in at least one subfield of a frame, and one reset signal may be supplied to the scan electrode during a reset period included in at least one of the other subfields of the frame.

For example, two reset signals may be supplied to the scan electrode during a reset period of the subfield first arranged in a frame as shown FIG. 11(a), and one reset signal during a reset period of the other subfields as shown in FIG. 11(b).

If at least two reset signals are used in at least one subfield, initialization process may be more easily performed, and if one reset signal is used in the other subfields, driving time may be reduced compared to a case where at least two reset signals are used in the overall subfields.

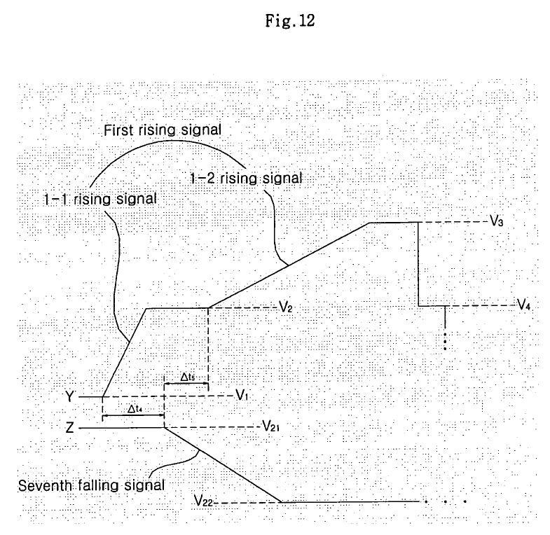

FIG. 12 is a timing diagram illustrating another type of reset signal according to an exemplary embodiment of the present invention.

Referring to FIG. 12, a ramp-up signal, for example a first ramp-up signal, may include a 1-1 ramp-up signal and a 1-2 ramp-up signal that are different in slope from each other.

The 1-1 ramp-up signal gradually rises from a first voltage V1 to a second voltage V2 with a first slope, and the 1-2 ramp-up signal gradually rises from the second voltage V2 to a third voltage V3 with a second slope.

The second slope of the 1-2 ramp-up signal is gentler than the first slope of the 1-1 ramp-up signal. This enables the voltage to increase relatively fast until a set-up discharge takes place and the voltage to increase relatively slowly during the set-up discharge. As a consequence, the amount of light emitted by the set-up discharge may be reduced. Therefore, contrast ration may be improved.

In this case, a ramp-down signal, whose voltage gradually decreases, is supplied to the sustain electrode while the 1-2 ramp-up signal is supplied to the scan electrode.

A time interval (Δt4) corresponds to the time interval (Δt2) shown in FIG. 4b, and a time interval (Δt5) to the time interval (Δt1).

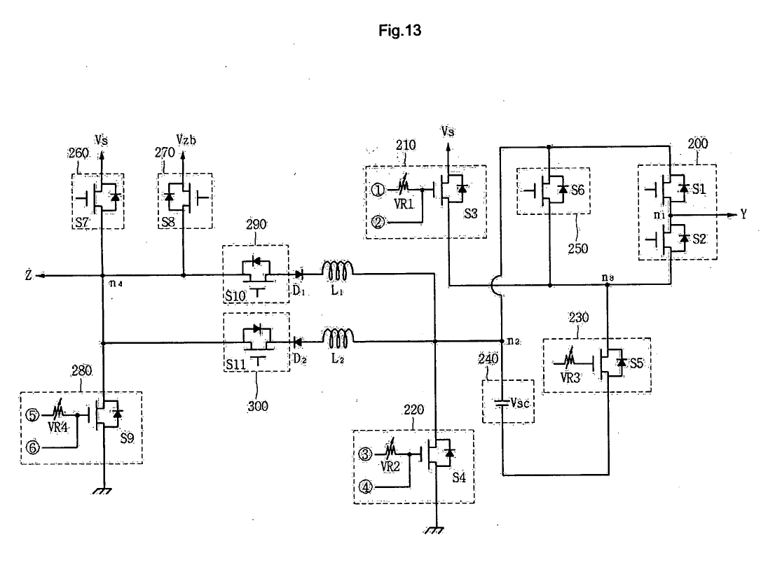

FIG. 13 is a circuit diagram illustrating an exemplary driver according to an exemplary embodiment of the present invention.

Referring to FIG. 13, the driver includes a sustain voltage switching unit 210, S3, a scan driver integrated circuit (IC) unit 200, a ramp-down switching unit 220, a scan voltage supplying unit 240, and a set-down switching unit 230.

The driver may further include a Z-sustain voltage switching unit 260, S7, a Z-ramp-down switching unit 280, S9, a bias switching unit 270, S8, a first ER (Energy Recovery) switching unit 290, S10, a second ER switching unit 300, S11, a first inductor L1, and a second inductor L2. In addition, the driver may further include a first diode D1 and a second diode D2 that prevents the incidence of a countercurrent.

The driver may further include a buffering switching unit 250, S6 between a first end of the first switching unit S1 and a second end of the second switching unit S2 in parallel with the scan driver IC unit 200.

The buffering switching unit S6 may distribute and relieve load of the scan driver IC unit 200 and prevent electrical damage to the scan driver IC unit 200.

The scan driver IC unit 200 includes a first switching unit S1 and a second switching unit S2. The scan electrode Y of the plasma display panel is connected to a common terminal of the first switching unit S1 and the second switching unit S2.

The sustain voltage switching unit S3 supplies a sustain voltage Vs to the scan electrode Y via a first path and the scan driver IC unit 200, and a ramp-up signal to the scan electrode Y via a second path different from the first path and the scan driver IC unit 200.

For this purpose, the sustain voltage switching unit S3 may include a first control terminal \textcircled{1} and a second control terminal \textcircled{2}, wherein the first control terminal \textcircled{1} may be connected to a first variable resistor VR1.

A control signal of the ramp-up signal may be supplied to the first control terminal \textcircled{1}, and a control signal of the sustain voltage Vs may be supplied to the second control terminal \textcircled{2}.

The sustain voltage switching unit S3 may be connected between the second end of the second switching unit S2 and a sustain voltage source that generates the sustain voltage Vs.

The first path leads from the sustain voltage source through the sustain voltage switching unit S3 and a third node n3 to the switching unit S2 of the scan drive IC unit 200.

The second path leads from the sustain voltage source through the sustain voltage switching unit S3, the third node n3, the set-down switching unit S5, the scan voltage supplying unit 240, and the second node n2 to the first switching unit S1 of the scan driver IC unit 200.

The ramp-down switching unit S4 supplies a ground voltage GND to the scan electrode Y via a third path different from the first and second paths and the scan driver IC unit 200, and a ramp-down signal to the scan electrode Y via a fourth path different from the first, second, and third paths and the scan driver IC unit 200.

For this purpose, the ramp-down switching unit S4 may include a third control terminal \textcircled{3} and a fourth control terminal \textcircled{4}, wherein the third control terminal \textcircled{3} may be connected to a second variable resistor VR2. A ground voltage GND control signal may be supplied to the control terminal \textcircled{4}, and a ramp-down control signal may be supplied to the control terminal \textcircled{3}. The ramp-down switching unit S4 may be connected between the first end of the first switching unit S1 and a ground terminal.

The third path leads from the first switching unit S1 through the second node n2 and the ramp-down switching unit S4 to the ground terminal.

The fourth path leads from the second switching unit S2 through the third node n3, the set-down switching unit S5, the scan voltage supplying unit 240, the second node n2, and the ramp-down switching unit S4 to the ground terminal.

The fourth path passes through the second path, the scan voltage supplying unit 240, and the set-down switching unit S5.

The scan voltage supplying unit 240 generates a scan voltage Vsc as a static voltage source. The scan voltage supplying unit 240 is connected between the first terminal of the first switching unit S1 and the second terminal of the second switching unit S2 in parallel with the scan driver IC unit 200.

The set-down switching unit S5 may be connected between a second terminal of the scan voltage supplying unit 240 and the second terminal of the second switching unit S2 in series with the scan voltage supplying unit 240.

This set-down switching unit S5 may have a third variable resistor VR3 connected to its control terminal.

The Z-sustain voltage switching unit S7 may supply the sustain voltage Vs to the sustain electrode Z.

The Z-sustain voltage switching unit S7 may be connected between the sustain electrode Z and a sustain voltage source that generates the sustain voltage Vs.

The Z-ramp-down switching unit S9 may supply a ground voltage GND to the sustain electrode Z. The Z-ramp-down switching unit S9 may supply a ramp-down signal to the sustain electrode Z.

For this purpose, the Z-ramp-down switching unit S9 may include a fifth control terminal \textcircled{5} and a sixth control terminal \textcircled{6}, wherein the fifth control terminal \textcircled{5} may be connected to a fourth variable resistor VR4.

A ground voltage GND control signal may be supplied to the sixth control terminal \textcircled{6}, and a ramp-down control signal may be supplied to the fifth control terminal \textcircled{5}.

The Z-ramp-down switching unit S9 may be connected between the sustain electrode Z and a ground terminal.

The bias switching unit 270, S8 may supply a sustain bias signal to the sustain electrode Z. This bias switching unit S8 may be connected between the sustain electrode Z and a bias voltage source that generates a bias voltage Vzb.

The first ER switching unit S10 recovers the voltage applied to the sustain electrode Z from the sustain electrode Z to the scan electrode Y.

The second ER switching unit S11 recovers the voltage applied to the scan electrode Y from the scan electrode Y to the sustain electrode Z.

The first ER switching unit S10 and the second ER switching unit S11 may be connected in parallel with each other between the second node n2 and the fourth node n4.

The first inductor L1 may LC-resonate the voltage collected from the sustain electrode Z and supplied to the scan electrode Y. The first inductor L1 is connected between the second node n2 and the first ER switching unit S10.

The second inductor L2 may LC-resonate the voltage collected from the scan electrode Y and supplied to the sustain electrode Z. The second inductor L2 is connected between the second node n2 and the second ER switching unit S11.

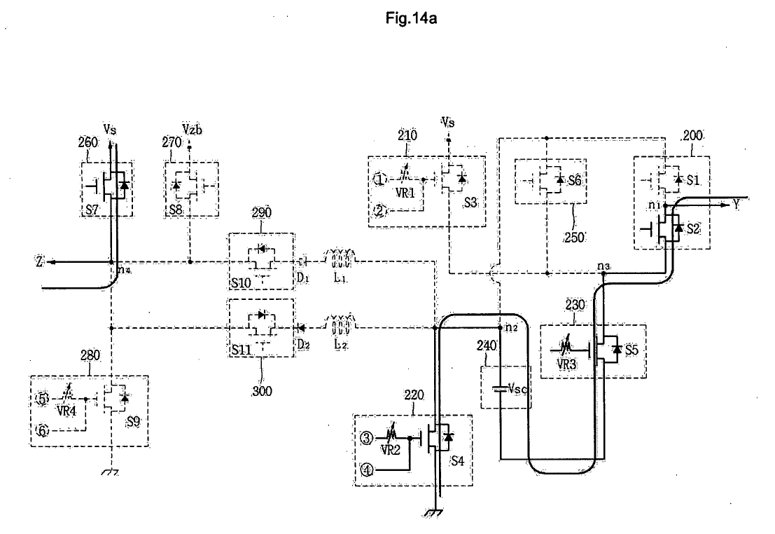

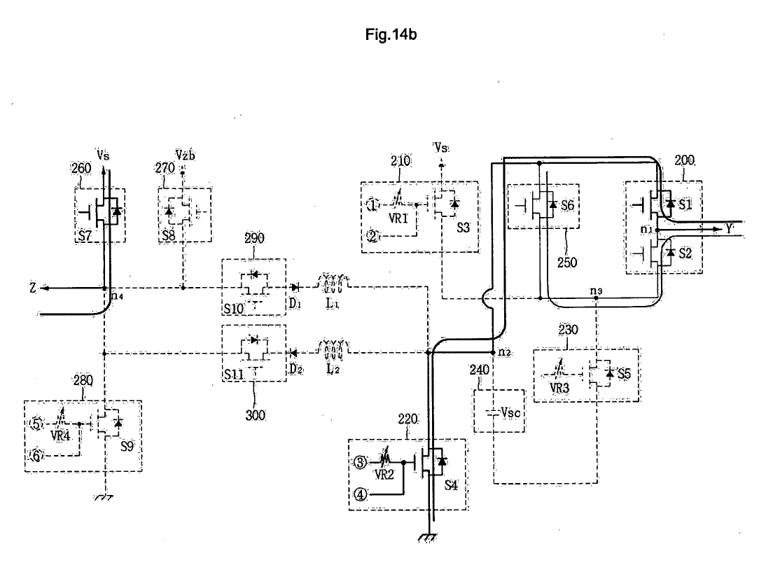

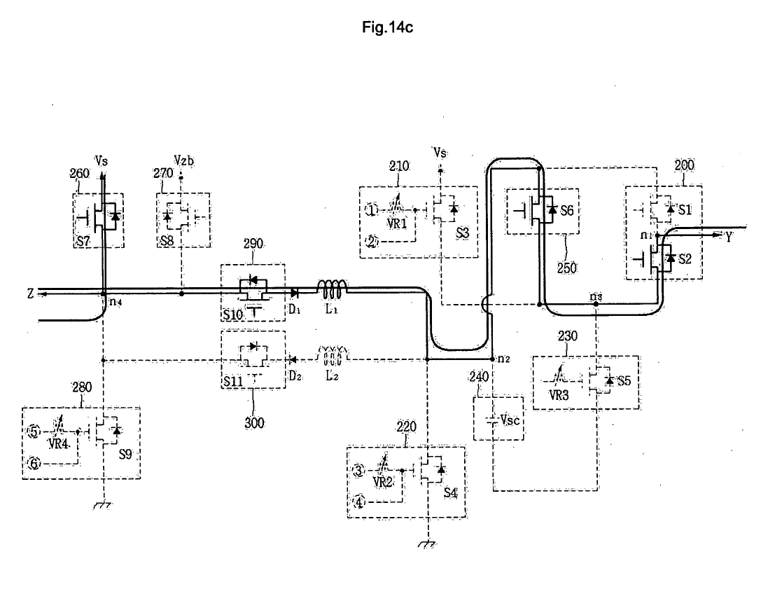

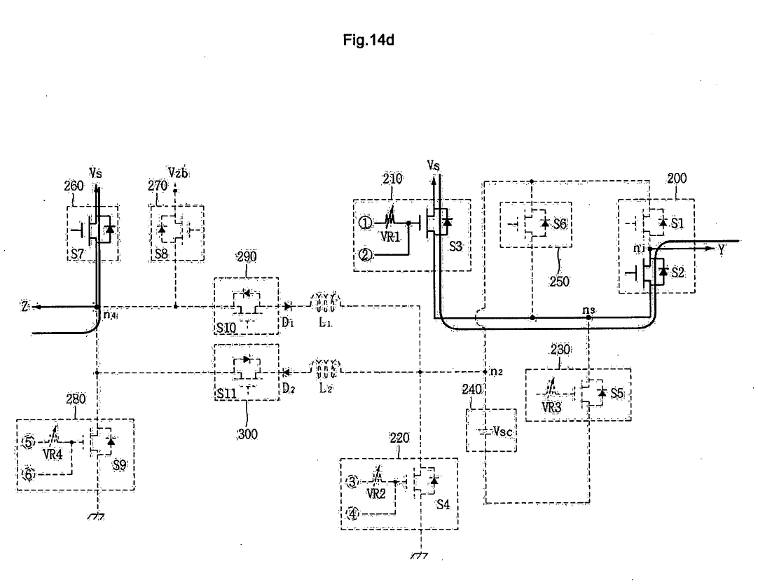

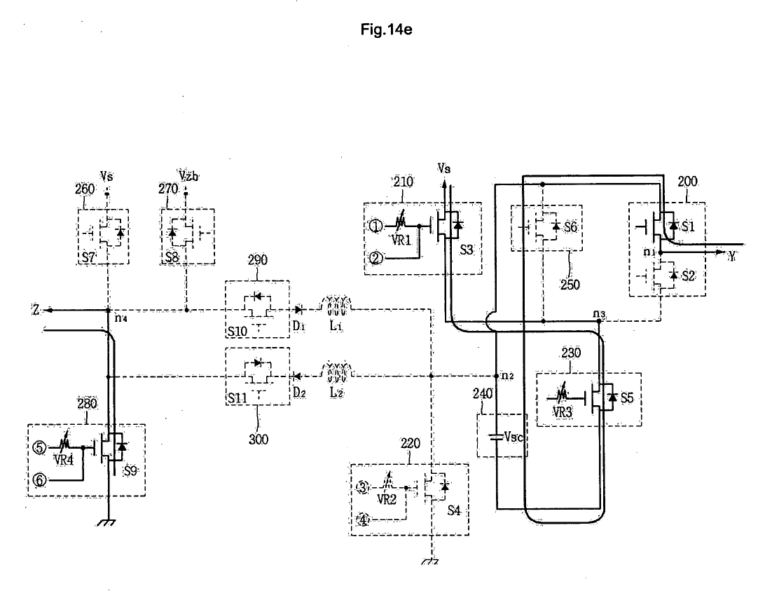

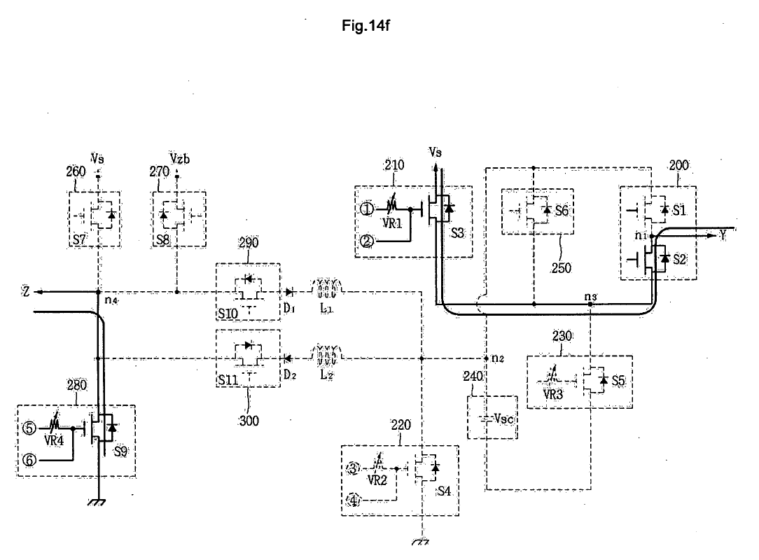

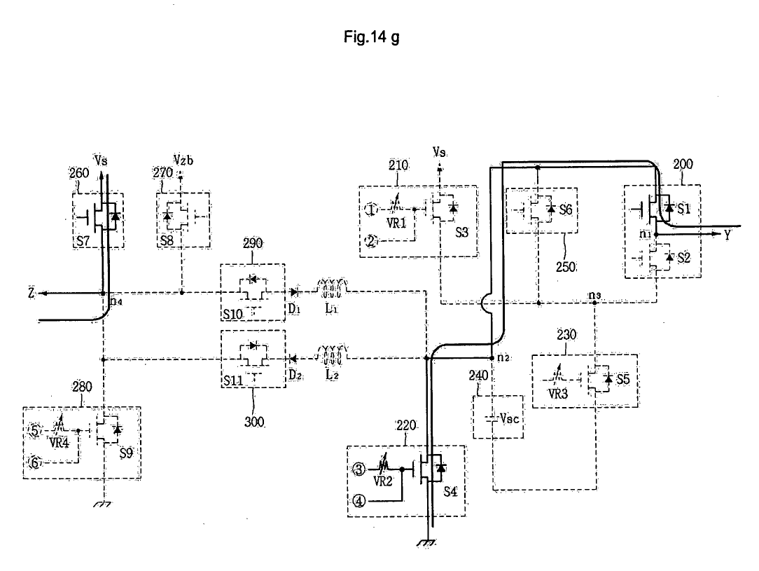

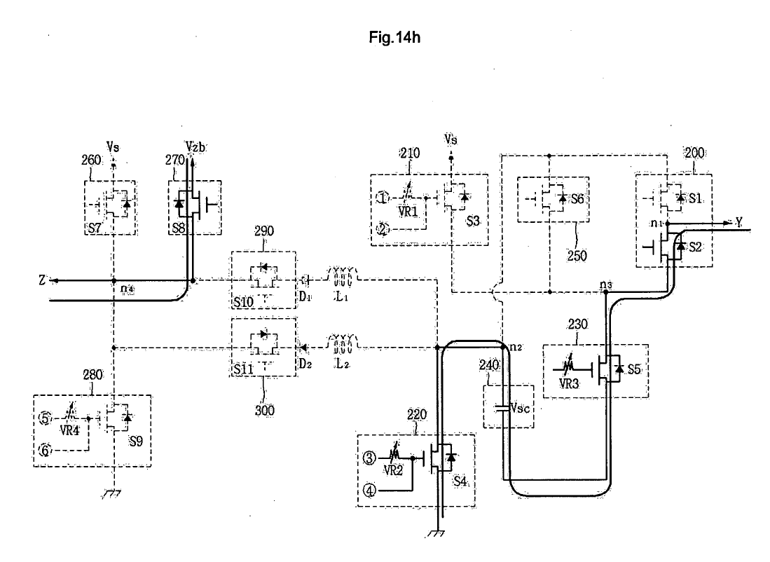

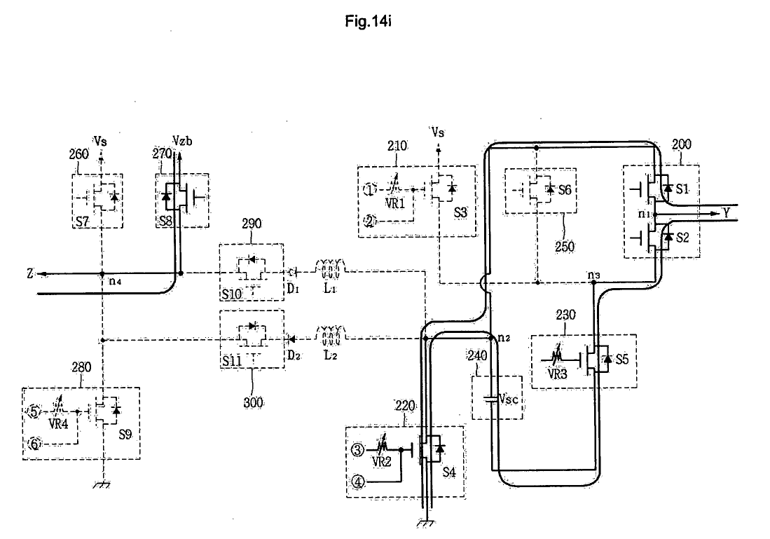

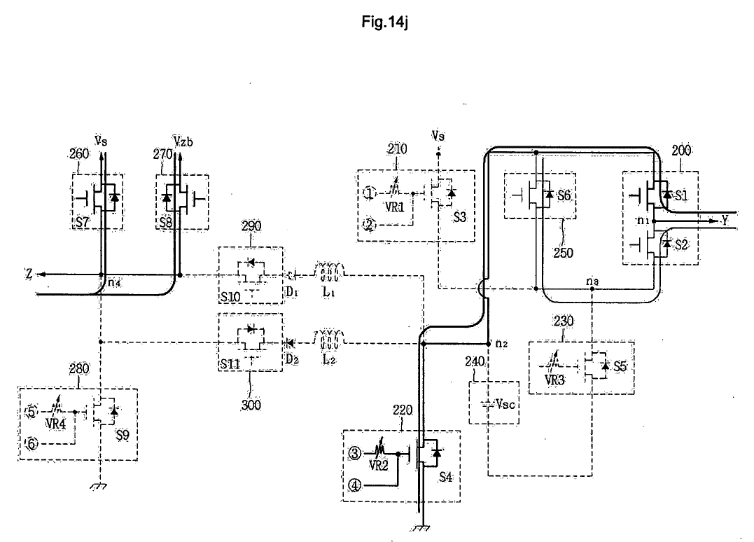

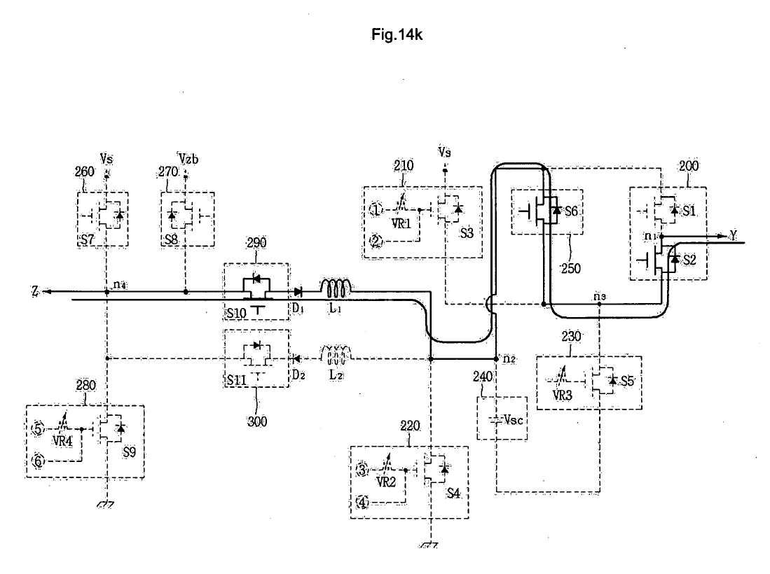

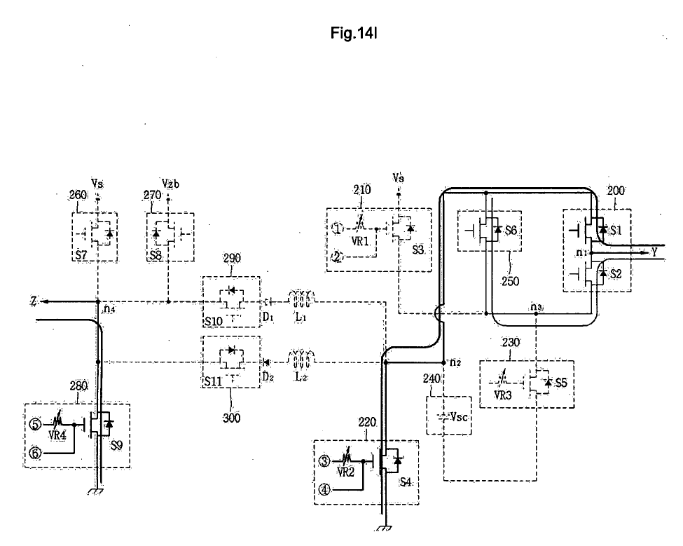

FIGS. 14a to 14l are circuit diagrams illustrating an exemplary operation of a driver according to an exemplary embodiment of the present invention.

Although FIGS. 14a to 14l depict exemplary operations of the driver shown in FIG. 13, the present invention is not limited thereto, but the driver may be operated in various manners. The descriptions will be made with reference to the driving signals shown in FIG. 4.

Referring to FIG. 14a, firstly, the Z-sustain voltage switching unit S7 turns on upon the pre-reset period prior to the reset period.

In addition, the second switching unit S2, the set-down switching unit S5, and the ramp-down switching unit S4 are turned on.

Then, the sustain voltage Vs supplied from the sustain voltage source is supplied to the sustain electrode Z via the Z-sustain voltage switching unit S7. Accordingly, the first sustain bias signal that has the twenty-first voltage V21 may be supplied to the sustain electrode Z. The twenty-first voltage V21 may be the sustain voltage Vs.

In this case, the ramp-down control signal is supplied to the third control terminal \textcircled{3} of the ramp-down switching unit S4, and the fourth path is created, which passes through the second switching unit S2, the set-down switching unit S5, the scan voltage supplying unit 240, the second node n2, the ramp-down switching unit S4 to the ground terminal.

Then, the channel width of the ramp-down switching unit S4 is adjusted by the second variable resistor VR2 connected to the third terminal \textcircled{3}, and the polarity of the scan voltage Vsc supplied from the scan voltage supplying unit 240 becomes negative as seen from the ground terminal. Accordingly, the voltage applied to the scan electrode Y may gradually fall from the fifth voltage V5 to the sixth voltage V6. That is, the first ramp-down signal may be supplied to the scan electrode.

A pre-dark discharge takes place in the discharge cell during the pre-reset period (PreReset), and this causes wall charges to be accumulated in the discharge cell.

As the wall charges are accumulated in the discharge cell during the pre-reset period, the reset discharge may occur further stably during the subsequent reset period. In addition, although the magnitude of the voltage of the reset signal supplied during the reset period is lowered, the wall charges may stay sufficiently uniform and stable in the discharge cell.

Subsequently, the first switching unit S1 turns on, and the second switching unit S2 and the set-down switching unit S5 turn off.

At this time, a ground voltage GND control signal is supplied to the fourth control terminal \textcircled{4} of the ramp-down switching unit S4, and a path, i.e. the third path, is created, which passes through the first switching unit S1, the second node n2, and the ramp-down switching unit S4 to the ground terminal.

Then, as shown in FIG. 14b, the ground voltage GND is supplied to the scan electrode Y via the ramp-down switching unit S4, so that the voltage applied to the scan electrode Y rises up to the first voltage V1, i.e. the ground voltage.

At this time, in a case where the buffering switching unit S6 turns on, a voltage supplying path may be created, which passes through the buffering switching unit S6 and a body diode of the second switching unit S2 to the scan electrode Y. Then, part of load applied to the first switching unit S1 may be distributed toward the buffering switching unit S6, and therefore, it can be possible to reduce the incidence of heat at the first switching unit S1.

The voltage supplying path passing through the buffering switching unit S6 has been marked with a solid line. Hereinafter, operations of the buffering switching unit S6 may be omitted from the descriptions.

Subsequently, the ramp-down switching unit S4 may turn off, and the first ER switching unit S10 may turn on.

Then, as shown in FIG. 14c, the voltage applied to the sustain electrode Z is collected from the sustain electrode Z to the scan electrode Y. At this time, an LC resonance is created by the first inductor L1, so that the voltage applied to the scan electrode Y may be raised by the LC resonance. For instance, the voltage applied to the scan electrode Y may rise from the first voltage V1 to the second voltage V2 by the LC resonance. In this case, the first voltage V1 may be the ground voltage GND, and the second voltage V2 may be the sustain voltage.

Next, the first ER switching unit S10 may turn off, and the sustain voltage switching unit S3 may turn on.

Then, as shown in FIG. 14d, the sustain voltage Vs generated from the sustain voltage source is supplied to the scan electrode Y via the sustain voltage switching unit S3, and therefore, the voltage applied to the scan electrode Y may be maintained as the second voltage V2.

Subsequently, the Z-sustain voltage switching unit S7 and the second switching unit S2 may turn off, and the Z-ramp-down switching unit S9, the first switching unit S1, and the set-down switching unit S5 may turn on.

Then, as shown in FIG. 14e, the voltage applied to the scan electrode Y may gradually rise from the second voltage V2 to the third voltage V3. That is, the first ramp-up signal may be supplied to the scan electrode Y.

At this time, the ramp-down control signal is supplied to the fifth control terminal \textcircled{5} of the Z-ramp-down switching unit S9, and a path is created, which passes through the fourth node n4 and the Z-ramp-down switching unit S9.

Then, the channel width of the Z-ramp-down switching unit S9 is adjusted by the fourth variable resistor VR4 connected to the fifth control terminal \textcircled{5}, so that the voltage applied to the sustain electrode Y may gradually fall from the twenty-first voltage V21 to the twenty-second voltage V22. That is, the seventh ramp-down signal may be supplied to the sustain electrode Z.

The third voltage V3 is a summed voltage of the sustain voltage Vs and the scan voltage Vsc.

Next, the first switching unit S1 and the set-down switching unit S5 may turn off. Then, as shown in FIG. 14f, the voltage applied to the scan electrode Y may fall down to the fourth voltage V4. The fourth voltage V4 may be the sustain voltage Vs.

Subsequently, the Z-ramp-down switching unit S9 and the sustain voltage switching unit S3 may turn off, and the Z-sustain voltage switching unit S7 and the ramp-down switching unit S4 may turn on.

Then, as shown in FIG. 14g, the sustain voltage Vs generated from the sustain voltage source is supplied to the sustain electrode Z via the Z-sustain voltage switching unit S7. That is, a second sustain bias voltage, maintaining a twenty-third voltage V23, for example, the sustain voltage Vs, is supplied to the sustain electrode Z.

At this time, the ramp-down control signal is supplied to the third control terminal \textcircled{3} of the ramp-down switching unit S4, and the fourth path is created, which passes through the body diode of the first switching unit S1, the second node n2, and the ramp-down switching unit S4 to the ground terminal.

A path, i.e. the first path, which passes through the set-down switching unit S5, the scan voltage supplying unit 240, the second node n2, and the ramp-down switching unit S4 to the ground terminal.

Then, the channel width of the ramp-down switching unit S4 is adjusted by the second variable resistor VR2 connected to the third control terminal \textcircled{3}. The voltage applied to the scan electrode Y gradually falls from the fourth voltage V4 to the fifth voltage V5. That is, the second ramp-down signal may be supplied to the scan electrode Y.

Next, the first switching unit S1 turns off, and the second switching unit S2 and the set-down switching unit S5 turn on. Then, the ramp-down control signal is supplied to the third control terminal \textcircled{3} of the ramp-down switching unit S4, and a path, i.e. the fourth path, is created, which passes through the second switching unit S2, the set-down switching unit S5, the scan voltage supplying unit 240, the second node n2, and the ramp-down switching unit S4 to the ground terminal.

Then, the channel width of the ramp-down switching unit S4 is adjusted by the second variable resistor VR2 connected to the third control terminal \textcircled{3}. In addition, the polarity of the scan voltage Vsc supplied from the scan voltage supplying unit 240 becomes negative as seen from the ground terminal, so that the voltage applied to the scan electrode Y may gradually fall from the fifth voltage V5 to the sixth voltage V6. That is, the third ramp-down signal is supplied to the scan electrode Y, which gradually falls from the fifth voltage V5 to the sixth voltage V6.

Subsequently, the first switching unit S1 turns on, and the second switching unit S2 and the set-down switching unit S5 turn off. Then, the ground voltage GND control signal is supplied to the fourth control terminal \textcircled{4} of the ramp-down switching unit S4, and a path, i.e. the third path is created, which passes through the first switching unit S1, the second node n2, and the ramp-down switching unit S4 to the ground terminal.

Then, as the ground voltage GND is supplied to the scan electrode Y via the ramp-down switching unit S4, the voltage applied to the scan electrode Y rises from the sixth voltage V6 to the seventh voltage V7.

Next, operations of the circuit associated with the second reset signal is substantially identical to that of the circuit associated with the first reset signal, and therefore, the repetitive descriptions will be omitted.

During the set-up period for the second reset signal, the voltage of the second reset signal maintains the eighth voltage V8 and then the Z-sustain voltage switching unit S7 and the second switching unit S2 may turn off, and the Z-ramp-down switching unit S9, the first switching unit S1, and the set-down switching unit S5 may turn on.

Then, the voltage applied to the scan electrode Y may gradually rise from the eighth voltage V8 to the ninth voltage V9. At this time, the ramp-down control signal is supplied to the fifth control terminal \textcircled{5} of the Z-ramp-down switching unit S9, and a path is created, which passes through the fourth node n4 and the Z-ramp-down switching unit S9.

Then, the channel width of the Z-ramp-down switching unit S9 is adjusted by the fourth variable resistor VR4 connected to the fifth control terminal \textcircled{5}, so that the voltage applied to the sustain electrode Y may gradually fall from the twenty-third voltage V23 to the twenty-fourth voltage V24. That is, the eighth ramp-down signal may be supplied to the sustain electrode Z.

The ninth voltage V9 is smaller than the third voltage V3.

During the second set-down period of the second reset period, the Z-sustain voltage switching unit S7, the first switching unit S1, and the ramp-down switching unit S4 are in ON state.

Then, the twenty-fifth voltage V25 is supplied to the sustain electrode Z. The twenty-fifth voltage V25 may be the sustain voltage Vs.

In addition, the eleventh voltage V11 is supplied to the scan electrode Y. The eleventh voltage V11 may be the ground voltage GND.

Subsequently, the Z-sustain voltage switching unit S7 and the first switching unit S1 turn off, and the bias switching unit S8, the second switching unit S2, and the set-down switching unit S5 turn on.

Then, as shown in FIG. 14h, the third sustain bias signal having the twenty-sixth voltage V26 is supplied to the sustain electrode Z, and a path is created, which passes from the scan electrode Y through the second switching unit S2, the set-down switching unit S5, the scan voltage supplying unit 240, the second node n2, and the ramp-down switching unit S4 to the ground terminal.

Then, the channel width of the ramp-down switching unit S4 is adjusted by the second variable resistor VR2 connected to the third control terminal \textcircled{3}. In addition, the polarity of the scan voltage Vsc generated from the scan voltage supplying unit 240 becomes negative as seen from the ground terminal, so that the fifth ramp-down signal may be supplied to the scan electrode Y, whose voltage gradually falls from the eleventh voltage V11 to the twelfth voltage V12.

Next, during the address period, the first switching unit S1 maintains ON state as shown in FIG. 14i, and then the second switching unit S2 and the set-down switching unit S5 instantly turn on. Then, the scan bias signal may be supplied to the scan electrode Y. In addition, a scan signal, falling from the scan bias signal, may be supplied to the scan electrode Y.

The voltage of the scan bias signal is substantially equal to the ground voltage GND, and the voltage of the scan signal (Scan) is substantially equal in magnitude to the scan voltage Vsc.

Meanwhile, a data signal may be supplied to the address electrode X, corresponding to the scan signal.

Then, an address discharge takes place in the discharge cell by the scan signal and the data signal.

Subsequently, the Z-sustain voltage switching unit S7 turns on, and the first switching unit S1 and the ramp-down switching unit S4 turn on.

Then, as shown in FIG. 14j, the voltage applied to the sustain electrode Z may rise from the twenty-sixth voltage V26 to the twenty-seventh voltage V27.

Next, during the sustain period, the Z-sustain voltage switching unit S7, the bias switching unit S8, the first switching unit S1, and the ramp-down switching unit S4 may turn off, and the second switching unit S2 and the first ER switching unit S10 may turn on.

Then, as shown in FIG. 14k, the voltage applied to the scan electrode Y rises up to the sustain voltage Vs.

Subsequently, the first ER switching unit S10 may turn off, and the Z-ramp-down switching unit S9 and the sustain voltage switching unit S3 may turn on.

Then, the voltage applied to the scan electrode Y maintains the sustain voltage Vs, and the voltage applied to the sustain electrode Z falls down to the ground voltage GND.

Next, during the sustain period, the Z-ramp-down switching unit S7, the sustain voltage switching unit S3, and the second switching unit S2 may turn off, and the first switching unit S1 and the second ER switching unit S11 may turn on.

Then, the voltage applied to the scan electrode Y falls down to the ground voltage GND, and the voltage applied to the sustain electrode Z rises from the ground voltage GND to the sustain voltage Vs.

During the sustain period, a sustain discharge occurs between the scan electrode Y and the sustain electrode Z. In this case, the sustain discharge may occur only in the discharge cell where an address discharge occurred during the address period, but not in the other discharge cells.

On the other hand, the Z-ramp-down switching unit S9, the ramp-down switching unit S4, and the first switching unit S1 may be in the On state near the end of the sustain period.

Then, as shown in FIG. 14l, the sixth ramp-down signal is supplied to the scan electrode Y, whose voltage gradually falls from the fourteenth voltage V14 to the fifteenth voltage V15, and then the voltage may be maintained as the fourteenth voltage V14.

Moreover, the ninth ramp-down signal may be supplied to the sustain electrode Z, whose voltage gradually falls down from the sustain voltage Vs near the end of the sustain signal SUSL supplied to the sustain electrode Z.

If the driver shown in FIG. 13 is operated in the above-mentioned method, stable driving is possible although the number of switching elements used for the driver is lessened, and therefore, manufacturing costs may be saved.

In addition, the plasma display panel may be driven with the driving circuit alone shown in FIG. 4, without separately providing a driving circuit for driving the sustain electrode Z and a driving circuit for driving the scan electrode Y, and this may further reduce the manufacturing costs as well as the size of driving board on which the driving circuit is mounted.

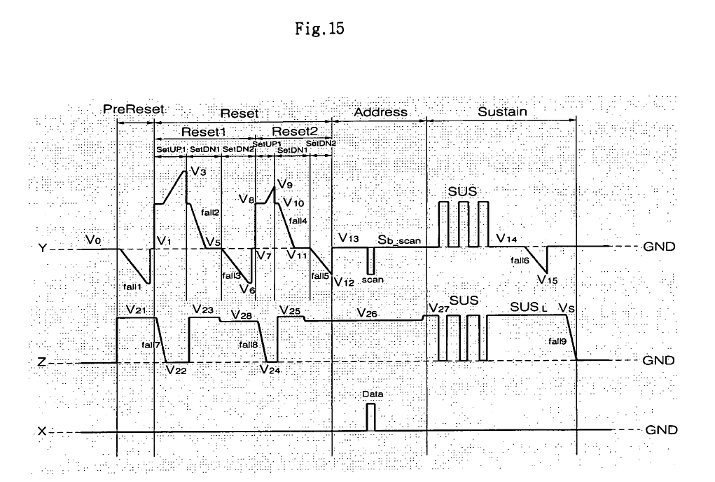

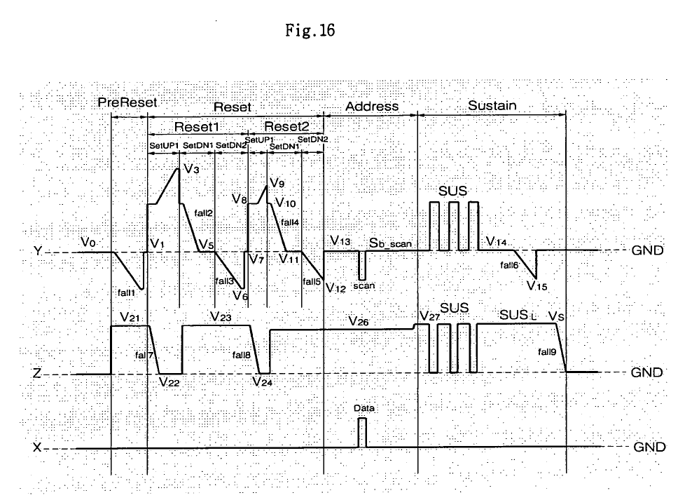

FIGS. 15 and 16 are timing diagrams illustrating a waveform of a driving signal of driving a plasma display panel according to an exemplary embodiment of the present invention.

In at least one of the first and second reset signals according to the exemplary embodiment of the present, the bias voltage applied to the sustain electrode during the first set-down period may be configured to be larger than the bias voltage applied to the sustain electrode during the second set-down period.

As shown in FIG. 15, the bias voltages V28 and V26 of the first and second reset signals, respectively, applied to the sustain electrode Z during the second set-down periods may be lowered than the bias voltages V23 and V25 during the first set-down periods, respectively. The sustain voltage may be lowered in accordance with the minimum voltage in the second set-down period, which is the minimum voltage in the reset period, and this may lead to a proper erase discharge because the sustain voltage may be lowered. Also, the magnitude of the bias voltage is adjusted according to the falling slope of the bias voltage during the second set-down period, which is gentler than that of the bias voltage during the other periods, and this may create more precise erase discharge.

In addition, as shown in FIG. 16, the bias voltage V23 applied to the sustain electrode Z during the set-down period for the first reset signal may be configured to be larger than the bias voltage V26 applied to the sustain electrode Z during the set-down period for the second reset signal, and this allows the number of switching operations to be minimized in the set-down period, and unnecessary wall charges to be removed in the set-down period for the second reset signal followed by the address period.

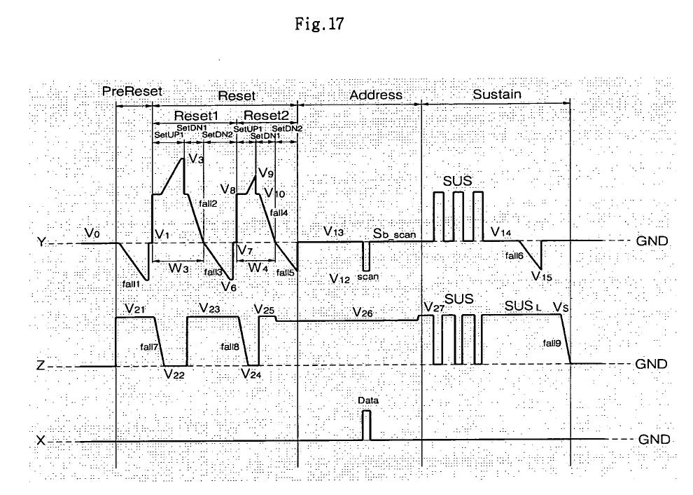

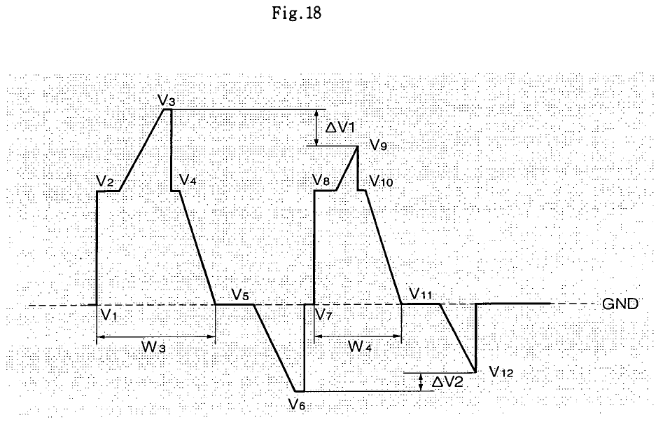

FIGS. 17 and 18 are timing diagrams illustrating a waveform of a driving signal of driving a plasma display panel according to an exemplary embodiment of the present invention.

A plasma display panel device according to an exemplary embodiment of the present invention includes a plasma display panel having an upper substrate on which a scan electrode and a sustain electrode are formed; and a driver supplying the scan electrode with a reset signal for initializing a discharge cell. The plasma display panel may be configured so that first and second reset signals are sequentially supplied to the scan electrode, the first and second signals including a set-up period during which voltages of the first and second signals gradually increase and first and second set-down periods during which voltages of the first and second signals gradually decrease, the set-up period and the first and second set-down periods included in at least one of plural subfields constituting one frame, wherein a period W3 during which a positive voltage of the first reset signal is supplied to the scan electrode is larger than a period W4 during which a positive voltage of the second reset signal is supplied to the scan electrode.

A voltage maintaining period may be omitted from between the first set-down period and the second set-down period as shown in FIG. 17. Also, a period during which the fifth voltage is maintained and a period during which the eleventh voltage is maintained may be added as shown in FIG. 18, for precise control of wall charges.

In at least one of the first and second reset signals according to the exemplary embodiment of the present, the bias voltage applied to the sustain electrode during the first set-down period may be configured to be larger than the bias voltage applied to the sustain electrode during the second set-down period. The sustain voltage may be lowered in accordance with the minimum voltage in the second set-down period, which is the minimum voltage in the reset period, and this may lead to a proper erase discharge because the sustain voltage may be lowered. Also, the magnitude of the bias voltage is adjusted according to the falling slope of the bias voltage during the second set-down period, which is gentler than that of the bias voltage during the other periods, and this may create more precise erase discharge.

Descriptions will be detailed with reference to FIG. 18. A period during which the voltage rises from the first voltage V1 to the third voltage V3 and then down to the fifth voltage V5, i.e. the positive voltage supplying period W3 of the first reset signal is longer than a period during which the voltage rises from the seventh voltage V7 to the ninth voltage V9 and then down to the eleventh voltage V11, i.e. the positive voltage supplying period W4 of the second reset signal.

A period of the reset signal during which a positive voltage is supplied to the scan electrode has a largest effect on reset discharges. Reset discharges by the first reset signal might be greatly occurring by making the positive voltage supplying period of the first reset signal W3 lengthy, and this causes wall charges to be sufficiently accumulated. In a case where a reset signal is only applied to the scan electrode Y once, the wall charges in the whole discharge cells may fail to remain suitable for an address discharge due to instability of the PDP. Accordingly, it can be possible for all the wall charges in the whole discharge cells to remain suitable for an address discharge, perform precise control of wall charges, and reduce the incidence of unwanted discharges by supplying the second reset signal to the scan electrode Y as in the above exemplary embodiment of the present invention.

For instance, the positive voltage supplying period of the first reset signal may be about 1.2 to about 1.7 times the positive voltage supplying period of the second reset signal. If the positive voltage supplying period of the first reset signal is less than 1.2 times the positive voltage supplying period of the second reset signal, such an effect may not be obtained that the first reset discharge takes place greatly, the sufficient amounts of wall charges are created by applying the second reset signal to the scan electrode Y, and therefore, controlling of wall charges are precisely performed. Furthermore, bright spots may take place since the voltage of the first reset signal abruptly falls down. If the positive voltage supplying period of the first reset signal is more than 1.7 times the positive voltage supplying period of the second reset signal, driving time increases greatly, and this may result in decrease in driving margin, disadvantage in high speed driving, and too high first reset discharge, which in turn may lead to deterioration in contrast ratio.

Since the width of the positive voltage supplying period of the first reset signal is increased to create the reset discharge greatly, the maximum voltage of the first reset signal may be larger than the maximum voltage of the second reset voltage.

The second reset signal is supplied to the scan electrode for accumulating wall charges once again and controlling the accumulated wall charges, and therefore, although the second reset signal does not reach the maximum voltage, the wall charges may remain uniformly in the discharge cell. In addition, voltage depletes less and therefore power consumption may be saved.

The voltage differential (ΔV1) between the third voltage V3 and the ninth voltage V9 may range from about 40V to about 60V. The voltage differential (ΔV1) needs to be more than 40V so that the plasma display panel device which is driven with a high voltage may reduce power consumption. Since the second reset signal is supplied to the scan electrode Y after the first reset signal has been supplied to the scan electrode Y, it is advantageous to use the wall charges caused due to the first reset discharge. In this case, however, if negative wall charges and positive wall charges are created at the scan electrode Y and at the sustain electrode Z, respectively, more than necessary, a strong discharge may take place, and this may give rise to image-sticking bright spots on the panel. Accordingly, the maximum voltage of the first reset signal may be about 40V above the maximum voltage of the second reset signal.

If the voltage differential (ΔV1) is more than 60V, the period during which the voltage gradually increases becomes too short, and this makes the set-up period of the second reset period meaningless. Accordingly, the negative wall charges created in the whole discharge cells by the second reset signal may be difficult to uniformly distribute near the scan electrode Y.

The twelfth voltage V12, which is the minimum voltage of the fifth ramp-down signal, is adapted to be higher than the sixth voltage V6, which is the minimum voltage of the third ram-down signal. This allows for the optimization of the amount of wall charges to be erased during the second set-down period of the second reset period, and therefore, it might be advantageous because sufficient amounts of wall charges may be utilized during an address period after the second reset period. In addition, the maximum voltage of the second reset signal during the set-up period is not large, and this makes it unnecessary to erase large amounts of wall charges. Similarly to the advantage coming from the voltage differential between the maximum voltages, power consumption might be saved.

The voltage differential (ΔV2) between the twelfth voltage V12, which is the minimum voltage of the second reset signal, and the sixth voltage V6, which is the minimum voltage of the first reset signal, may range from about 5V to about 20V. If the voltage differential (ΔV2) is less than 5V, this voltage differential becomes meaningless in terms of losses in circuit, influence from noises, voltage peaking, etc. If the voltage differential (ΔV2) is more than 20V, it could be difficult to ensure sufficient set-down period of the second reset signal, and this may lead to a failure of erase of wall charges. A consequence may be the incidence of unwanted discharges.

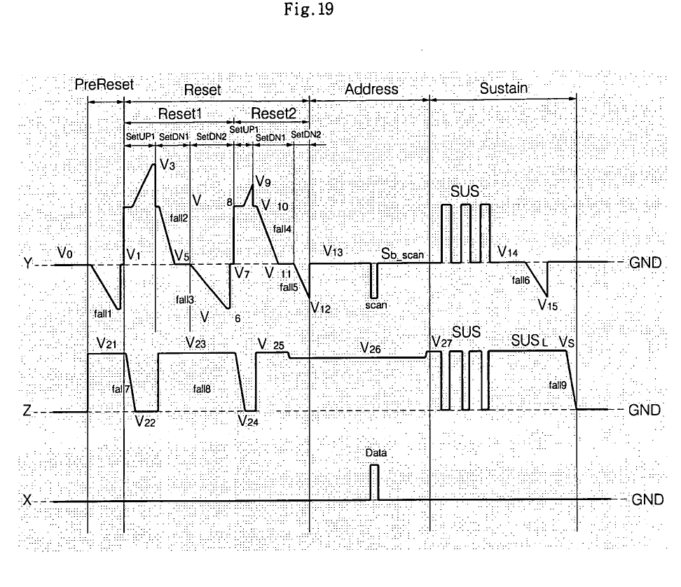

FIG. 19 is a timing diagram illustrating a waveform of a driving signal of driving a plasma display panel according to an exemplary embodiment of the present invention.

A plasma display panel device according to an exemplary embodiment of the present invention includes a plasma display panel having an upper substrate on which a scan electrode and a sustain electrode are formed; and a driver supplying the scan electrode with a reset signal for initializing a discharge cell, wherein first and second reset signals are sequentially supplied to the scan electrode, the first and second signals including a set-up period during which voltages of the first and second signals gradually increase and a set-down period during which voltages of the first and second signals gradually decrease, the set-up period and the set-down period included in at least one of plural subfields constituting one frame, wherein in at least one of the first and second reset signals, the set-down period includes a first set-down period during which a voltage of the at least one of the first and second reset signals gradually decreases, and a second set-down period during which a falling slope of the voltage is gentler than a falling slope of the voltage during the first set-down period.

The strength of the discharge occurring during the second set-down period may weaken by having the falling slope of the voltage during the second set-down period gentler than the falling slope of the voltage during the first set-down period, and this may improve contrast ratio of the plasma display panel device.

The first set-down period of the first and second reset periods may further include a time period (hereinafter, referred to as “floating period” during which the voltage gradually falls down and then floats at a constant level for a constant time. The floating period may be adjusted to stably erase unnecessary wall charges while permitting strong discharges not to occur during the set-down period.

In at least one of the first set-down period and the second set-down period, a falling slope of the reset signal may range from about −1.4V/us to about −2.4V/us within a period during the voltage gradually falls down in the reset period, i.e. period during which each of the second, the third, the fourth, and the fifth ramp-down signals is supplied to the scan electrode Y. If the falling slope is less than −1.4V/us, the reset period lasts too long, and this may reduce the driving margin. And, if the falling slope is more than −2.5V/us, the voltage may abruptly fall down, and this may cause a discharge.

Although a case has been shown in FIG. 19, where the set-down period includes the first set-down period during which the voltage of the first reset signal gradually decreases, and the second set-down period during which the falling slope of the voltage is gentler than the falling slope of the voltage during the first set-down period, the present invention is not limited thereto. For instance, both of the first and second reset signals may have the second set-down period during which the falling slope of the voltage is gentler than the falling slope of the voltage during the first set-down period.

As such, the strength of the set-down discharge may be more precisely adjusted depending on driving environments of the plasma display panel by adjusting the bias voltage supplied to the sustain electrode according to variation in slope during the set-down period.

Also, in at least one of the first and second reset signals, the bias voltage applied to the sustain electrode during the first set-down period may be larger than a bias voltage applied to the sustain electrode during the first set-down period. Since the voltage during the second set-down period is lowest, the bias during the second set-down period is helpful to stably erase the wall charges. The strength of the set-down discharge is adjusted by properly controlling voltage differential between the scan electrode and the sustain electrode depending on driving environments, thus ensuring more stable driving.

The foregoing embodiments and advantages are merely exemplary and are not to be construed as limiting the present invention. The present teaching can be readily applied to other types of apparatuses. The description of the foregoing embodiments is intended to be illustrative, and not to limit the scope of the claims. Many alternatives, modifications, and variations will be apparent to those skilled in the art.

What is claimed is:

1. A plasma display panel device comprising a plasma display panel having an upper substrate on which a scan electrode and a sustain electrode are formed; and a driver supplying the scan electrode with a reset signal for initializing a discharge cell, wherein
first and second reset signals are sequentially supplied to the scan electrode, the first and second signals including a set-up period during which voltages of the first and second signals gradually increase and a set-down period during which voltages of the first and second signals gradually decrease, the set-up period and the set-down period included in at least one of plural subfields constituting one frame, wherein
the set-down period of the first and second reset periods includes a first set-down period during which the voltages of the first and second signals gradually decrease from a positive voltage and a second set-down period during which the voltages of the first and second signals gradually decrease to a negative voltage.

2. The plasma display panel device of claim 1, wherein
a maximum voltage of the first reset signal is larger than a maximum voltage of the second reset signal.

3. The plasma display panel device of claim 2, wherein
a difference between the maximum voltage of the first reset signal and the maximum voltage of the second reset signal ranges from about 40V to about 60V.

4. The plasma display panel device of claim 1, wherein
a minimum voltage of the second reset signal is higher than a minimum voltage of the first reset signal.

5. The plasma display panel device of claim 4, wherein
a difference between the minimum voltage of the first reset signal and the minimum voltage of the second reset signal ranges from about 5V to about 20V.

6. The plasma display panel device of claim 1, wherein
in at least one of the first set-down period and the second set-down period, a falling slope of the reset signal ranges from about −1.4V/us to about −2.4V/us.

7. The plasma display panel device of claim 1, wherein
in at least one of the first and second reset signals, a bias voltage applied to the sustain electrode during the first set-down period is larger than a bias voltage applied to the sustain electrode during the second set-down period.

8. The plasma display panel device of claim 1, wherein
a bias voltage applied to the sustain electrode during the set-down period of the first reset signal is larger than a bias voltage applied to the sustain electrode during the set-down period of the second reset signal.

9. The plasma display panel device of claim 1, wherein
a bias voltage applied to the sustain electrode during the second set-down period of the first reset signal is larger than a bias voltage applied to the sustain electrode during the second set-down period of the second reset signal.

10. A plasma display panel device comprising a plasma display panel having an upper substrate on which a scan electrode and a sustain electrode are formed; and a driver supplying the scan electrode with a reset signal for initializing a discharge cell, wherein
first and second reset signals are sequentially supplied to the scan electrode, the first and second signals including a set-up period during which voltages of the first and second signals gradually increase and first and second set-down periods during which voltages of the first and second signals gradually decrease, the set-up period and the first and second set-down periods included in at least one of plural subfields constituting one frame, wherein
a period during which a positive voltage of the first reset signal is supplied to the scan electrode is larger than a period during which a positive voltage of the second reset signal is supplied to the scan electrode.

11. The plasma display panel device of claim 10, wherein
the period during which the positive voltage of the first reset signal is supplied to the scan electrode is about 1.2 to about 1.7 times the period during which the positive voltage of the second reset signal is supplied to the scan electrode.

12. The plasma display panel device of claim 10, wherein
a maximum voltage of the first reset signal is larger than a maximum voltage of the second reset signal.

13. The plasma display panel device of claim 12, wherein
a difference between the maximum voltage of the first reset signal and the maximum voltage of the second reset signal ranges from about 40V to about 60V.

14. The plasma display panel device of claim 10, wherein
a minimum voltage of the second reset signal is higher than a minimum voltage of the first reset signal.

15. The plasma display panel device of claim 14, wherein
a difference between the minimum voltage of the first reset signal and the minimum voltage of the second reset signal ranges from about 5V to about 20V.

16. The plasma display panel device of claim 10, wherein
in at least one of the first and second reset signals, a bias voltage applied to the sustain electrode during the first set-down period is larger than a bias voltage applied to the sustain electrode during the second set-down period.

17. A plasma display panel device comprising a plasma display panel having an upper substrate on which a scan electrode and a sustain electrode are formed; and a driver supplying the scan electrode with a reset signal for initializing a discharge cell, wherein
first and second reset signals are sequentially supplied to the scan electrode, the first and second signals including a set-up period during which voltages of the first and second signals gradually increase and a set-down period during which voltages of the first and second signals gradually decrease, the set-up period and the set-down period included in at least one of plural subfields constituting one frame, wherein
in at least one of the first and second reset signals, the set-down period includes a first set-down period during which a voltage of the at least one of the first and second reset signals gradually decreases, and a second set-down period during which a falling slope of the voltage is gentler than a falling slope of the voltage during the first set-down period.

18. The plasma display panel device of claim 17, wherein
the first set-down period of the first and second reset signals includes a period during which the voltage gradually decreases and floats at a constant level.

19. The plasma display panel device of claim 17, wherein
in at least one of the first set-down period and the second set-down period, a falling slope of the reset signal ranges from about −1.4V/us to about −2.4V/us.

20. The plasma display panel device of claim 17, wherein
in at least one of the first and second reset signals, a bias voltage applied to the sustain electrode during the first set-down period is larger than a bias voltage applied to the sustain electrode during the second set-down period.
